(19) United States
(12) Patent Application Publication
(10) Pub. No.: US 2008/0291574 A1
(43) Pub. Date: Nov. 27, 2008

(54) Fluid Dynamic Pressure Bearing, Spindle Motor Using the Fluid Dynamic Pressure Bearing and Recording Disk Drive Unit Using the Spindle Motor

(76) Inventor: Rikuro Obara, Kitasaku-gun (JP)

Correspondence Address: SCHULTE ROTH & ZABEL LLP;ATTN: JOEL E. LUTZKER, 919 THIRD AVENUE, NEW YORK, NY, 10022, US

(21) Appl. No.: 11/629,259

(22) PCT Filed: Jun. 9, 2005
(86) PCT No.: PCT/US05/20321

§ 371 Date: Dec. 11, 2006

(30) Foreign Application Priority Data
Jun. 11, 2004 (JP) 2004-174866
May 13, 2005 (JP) 2005-141974

(51) Int. Cl. G11B 33/12; F16C 17/10; F16C 33/08; F16C 33/10; F16C 35/02; H02K 15/14

(52) U.S. Cl. 360/224; 384/112; 310/42; G9B/5.229

(57) ABSTRACT

A shaft body 2 of a fluid dynamic bearing having a flange portion 4 at one end is supported rotatably via radial direction micro clearances by the sleeve 5 having a dynamic pressure generating groove 11 on the inner peripheral portion. A flange portion 4 is inserted between the lower end surface of the sleeve 5 and end plate 7. A dynamic pressure generating groove 12 is formed on the lower end surface of sleeve 5, and a dynamic pressure generating groove 13 is formed on the upper surface of the endplate 7. The lower end surface of the sleeve 5 and the upper surface of the flange portion 4, and the upper surface of the end plate 7 and the lower surface of the flange portion 4 are facing each other via respective thrust direction micro clearances. Sleeve 5 is inserted into the case 6 such that the upper end surface is projected from the upper end surface of the case 6. The outer peripheral face of the sleeve is fixed at the upper end of the case 6 by filling an adhesive in an adhesive reservoir formed between the sleeve 5 and the case 6. Adhesion and leakage of the adhesive to the locations other than the specified locations to be filled can be prevented, the number of manufacturing steps for the fluid dynamic bearing is reduced, quality is maintained, mass producibility is improved and low cost production is achieved.

This application claims priority based on the following Japanese patent applications: 2004-174866, filed Jun. 11, 2004; and 2005-141974, filed May 13, 2005.

### BACKGROUND OF THE INVENTION

1. Field of the Invention

The invention described in this patent application relates to fluid dynamic pressure bearings (bearings) that can be mass-produced at a low cost and with high quality, particularly those bearings suited for use with a spindle motor used for magnetic disk, optical disk or other memory storage devices, for example, a CD or a DVD.

2. Description of the Related Art

In recent years, the demand has been strong for increasingly smaller, thinner, lighter and higher-density magnetic disk, optical disk and other memory storage devices used in computers. For this reason, there is a demand for acceleration of rotation speed and increase of rotational accuracy of the spindle motors used for disk rotation. In order to meet this demand, rotational bearings like fluid dynamic bearing are used to replace conventional ball bearings. In a fluid dynamic bearing, lubricant is used to generate fluid dynamic pressure to support the rotating shaft. The requested volume of the fluid dynamic bearing is increasingly large. However, the problem with these fluid dynamic pressure bearings is that it is difficult to mass-produce them at high quality and low cost due to their high dimensional accuracy and also due to the fact that manufacturing is not easy.

FIG. 10 shows an example of a conventional fluid dynamic pressure bearing 01. The bearing 01 includes a rotating shaft 02 having a flange part 04. The flange part 04 is attached to one end (the lower end in FIG. 10) of the rotating shaft body 03. A cylindrical sleeve 05 supports the rotating shaft 02 in such a way that relative rotation is free. A tube-shaped case 06 houses the cylindrical sleeve 05 and a discoid endplate 07 blocks the lower end part of case 06. The sleeve 05 is fitted into case 06 and the outer circumferential side of the upper end part of sleeve 05 is fixed to the upper end part of the case 06 with an adhesive 19. The endplate 07 is fitted into the diametrically expanded shoulder of the lower end part of case 06, and is fixed there by an adhesive 21. Anaerobic thermosetting adhesives and epoxy thermosetting adhesives are conventionally used, and for these adhesives to set completely it is necessary to maintain them at a temperature of 80 to 100° C. for a definite period of time.

The flange part 04 is sandwiched between the lower end surface 05a of the sleeve 05 and the upper surface 07a of the endplate 07. The lower end surface 05a of the sleeve 05 and the upper surface 04a of the flange part 04, as well as the upper surface 07a of the endplate 07 and the lower surface 04b of the flange part 04, oppose each other via the thrust microgaps.

A first dynamic pressure generating groove 011 is formed between the inner circumferential surface 05b of the sleeve 05 and the facing outer circumferential surface 03a of the rotating shaft body 03 to generate the dynamic pressure that will bear the radial load. A second dynamic pressure generating groove 012 is also formed between the lower end surface 05a of the sleeve 05 and the facing upper surface 04a of the flange part 04 to generate the dynamic pressure that will bear the axial load. A third dynamic pressure generating groove 013 is formed between the upper surface 07a of the endplate 07 and the facing lower surface 04b of the flange part 04 in order to generate the dynamic pressure that will bear the axial load. A lubricant 010 surrounds the rotating shaft 02 with the flange part 04 and fills in the pouch-shaped bearing gap.

This pouch-shaped bearing gap is formed by linking together the radial bearing gap formed between the inner circumferential surface 05b of the sleeve. 05 and the outer circumferential surface 03a of the rotating shaft body 03, the axial bearing gap formed between the lower end surface 05a of the sleeve 05 and the upper surface 04a of the flange part 04, the radial bearing gap formed between the outer circumferential surface of the flange part 04 and the inner circumferential surface of the case 06, and the axial bearing gap formed between the upper surface 07a of the endplate 07 and the lower surface 04b of the flange part 04.

Accordingly, when the rotating shaft 02 rotates, said rotating shaft 02 is supported by the radial and axial fluid dynamic pressure created by the radial dynamic pressure generating grooves 011 and axial dynamic pressure generating grooves 012, 013, and it rotates without contacting the inner circumferential surface 05b of the sleeve 05, the lower end surface 05a of the sleeve 05, the inner circumferential surface of the case 06, or the upper surface 07a of the endplate 07.

FIG. 11 shows another example of a conventional fluid dynamic pressure bearing 01. In the fluid dynamic pressure bearing 01, the case 06 and the endplate 07 from the example of the conventional model in FIG. 10 have been unified to form a cup-shaped case 06 with a closed bottom. A sleeve 05 is fitted into the cup-shaped case 06, and the outer circumferential side of the upper end part of sleeve 05 is fixed on the inner circumferential surface of the cup-shaped case 06 with an adhesive 019. A discoid seal cover 09 is fitted into the upper end part of the cup-shaped case 06 by an adhesive 020. The center of this seal cover 09 has a hole through which the body 03 of a rotating shaft 02 passes through. The seal cover 09 connects with the upper end surface of the sleeve 05 and covers it.

Furthermore, in cases where the fluid dynamic pressure bearing 01 has a flange part 04 attached to the other end (the upper end in FIG. 11) of the rotating shaft body 03, the seal cover 09 faces the upper surface of the flange part 04 and restricts the upward movement, thus accomplishing the function of retaining the flanged rotating shaft 02.

A spacer 08 is provided between the lower surface 05a of the sleeve 05 and the bottom surface 06a of the cup-shaped case 06. A fixed space between the lower surface 05a of the sleeve 05 and the bottom surface 06a of the cup-shaped case 06 is provided via this spacer 08, and this maintains the bearing gap adjacent to the upper and lower surfaces of the flange part 04. The remaining features of the example of FIG. 11 are the same as the example of FIG. 10.

All of the main components of the conventional examples above are manufactured by precision machine processing mainly consisting of turning and polishing. Precision machine tools and machining technology is necessary to carry out this precision processing. Also, the machining time required for precision processing presents a problem for mass production. Manufacturing of the cup-shaped case 06 in particular requires long machining time.

Furthermore, there is a problem with the adhesive fastening (FIG. 10, FIG. 11) of the outer circumferential side of the upper end part of the sleeve 05 with the upper end part of the case 06 and with the adhesive fastening (FIG. 11) of the seal cover 09 with the upper end part of the cup-shaped case 06. The adhesives 019, 020 overflow onto the upper end surface of the sleeve 05 and the upper surface of the seal cover 09, get into the inner circumferential surface of the sleeve 05, and adhere to said inner circumferential surface and to the outer circumferential surface of the rotating shaft 02. This problem, which is an important issue, accompanies especially the miniaturized fluid dynamic pressure bearings, where it occurs increasingly easily because of reductions in the radial distance between the injection site of the adhesive and the inner circumferential edge of the sleeve. So, in order to prevent this, it is necessary to have countermeasures to optimize the amount of the adhesive, and to prevent adhesion and discharge outside of the prescribed filling site while filling in the adhesive and during the period after filling before the adhesive dries. Further problems are created requiring countermeasures during handling and assembling. Examples of conventional technology, wherein the two mating tubular components are fixed by an adhesive injected from injection hole specially provided, and from there the adhesive spreads over the whole area of the mating surface via the capillary phenomenon, are found in unexamined Japanese patent applications: 2002-061637, 2000-320542, 2004-003582 and 62-087857.

### SUMMARY

The present invention solves the problems found in the conventional fluid dynamic pressure bearings as described above and reduces unnecessary work such as removal of the adhesive from areas outside the prescribed filling site by preventing the adhesive from adhering to the inner circumferential surface and other areas outside the prescribed filling site, and by preventing the adhesive from flowing out before it hardens completely. In addition, this invention provides a fluid dynamic pressure bearing having a structure that makes it possible to reduce the manufacturing steps required by precision machine processing of the case, which is one of the important components of the fluid dynamic pressure bearing. In this way, the quality of the bearing can be maintained while improving mass production in the manufacturing and achieving much lower costs.

The present invention provides a fluid dynamic pressure bearing wherein free rotation of a rotating shaft having a flange part on one end (the lower end) is supported via radial microgaps between the shaft and the sleeve having radial dynamic pressure generating grooves on the inner circumference. The flange part is inserted and held sandwiched between the lower end surface of said sleeve where thrust dynamic pressure generating grooves are formed and the upper surface of the endplate where additional thrust dynamic pressure generating grooves are formed. The lower end surface of said sleeve and the upper surface of said flange part, and the upper surface of said endplate and the lower surface of said flange part are respectively made to oppose each other via thrust microgaps. The endplate is fixed onto the lower end part of a case. The upper end surface of the sleeve projects out from the upper end surface of said case. A first reservoir for an adhesive is formed between the case and the sleeve in a position facing the upper end part of said case. The outer circumferential surface of said sleeve is attached onto the inner circumferential surface of the case by the adhesive filling the first reservoir.

Another embodiment of the present invention provides a fluid dynamic pressure bearing wherein free rotation of a rotating shaft having a flange part on another end (the upper end) is supported via radial microgaps next to the sleeve having radial dynamic pressure generating grooves on the inner circumferential surface. The flange part is placed on the upper end surface of the sleeve where thrust dynamic pressure generating grooves are formed. The upper end surface of said sleeve and the lower surface of said flange part oppose each other via thrust microgaps. The upper end surface of said sleeve projects out from the upper end surface of a case. A first reservoir for an adhesive is formed between the case and the sleeve in a position facing the upper end part of the case, and the outer circumferential surface of said sleeve is attached to the inner circumferential surface of said case by the adhesive filling the first reservoir.

When the sleeve is fastened to the case by the adhesive, the outer circumferential surface of the sleeve which projects out from the upper end surface of the case is attached to the upper end part of the case by the adhesive filling the first reservoir. Because of this, it is possible to prevent the adhesive from getting into the inner circumferential surface of the sleeve and adhering to the inner circumferential surface of the sleeve and other areas outside of the prescribed filling site during the filling of the adhesive. The adhesive no longer discharges onto the outer parts before it has completely set due to handling posture or external force, and it is possible to reduce unnecessary work such as removal of the adhesive that has discharged or adhered in an area outside the prescribed filling site. This effect becomes more and more striking as the radial distance between the injection site of the adhesive and the inner circumferential edge of the sleeve becomes smaller, and particularly accompanies the miniaturization of fluid dynamic pressure bearings.

Also, since the axial length of the case is shortened, it is easier to manufacture the case by machining, tube rolling or press processing. The manufacture of the fluid dynamic pressure bearing requires fewer materials, and mass production of the fluid dynamic pressure bearings at lower costs is made possible.

In another embodiment, the upper end part of the case is diametrically expanded, forming a diametrically expanded upper end part. By forming the first reservoir of the adhesive between this diametrically expanded upper end part and the outer circumferential surface of the sleeve, the process of filling is made easier.

This way, during the adhesive filling time, the adhesive is securely retained in the first reservoir formed between the diametrically expanded upper end part of the case and the outer circumferential surface of the sleeve. Not only is adhesion prevented outside this prescribed filling site, but also during the state before the adhesive is completely set, the adhesive no longer discharges to outer areas due to handling posture or from external force, and it is possible to reduce unnecessary work such as removal of adhesive that has discharged or adhered in areas outside the prescribed filling site. Furthermore, the outer circumferential surface of the sleeve is reliably fixed to the inner circumferential surface of the case and the mating gap between the two is completely sealed with adhesive.

In another embodiment, a seal cover that is fitted onto and covers the outer circumferential surface part of the sleeve that projects out from the upper end surface of the case. A second reservoir for an adhesive is formed between the seal cover and the sleeve in a position facing the lower end part of the seal cover. The inner circumferential surface of the seal cover is fixed to the outer circumferential surface of the sleeve by the adhesive filling said second reservoir.

In this way, the outer part of the aperture end of the bearing is sealed, preventing contamination of the bearing part. Also, since the inner circumferential surface of the seal cover is fixed to the outer circumferential surface of the sleeve by the adhesive filling the second reservoir, it is possible to prevent the adhesive from adhering to the inner circumferential surface of the sleeve and other areas outside the prescribed filling site by penetrating into the upper surface of the seal cover and the inner circumferential surface of the sleeve. Also, the adhesive no longer discharges onto the outer parts before it has completely set due to the handling posture or external force, and it is possible to reduce unnecessary work such as removal of the adhesive that has discharged or adhered in an area outside the prescribed filling point.

By selecting appropriate viscosity of the adhesive for filling the mating gap formed between the outer circumferential surface of the sleeve and the inner circumferential surface of the case, the mating gap can be filled in an airtight and secure manner by the adhesive filling the reservoir, which passes over the whole area of the outer circumferential surface of the sleeve and the inner circumferential surface of the case due to the capillary phenomenon. The sleeve is thus fixed securely to the case by the adhesive, and it is thus possible to reliably prevent the lubricant that fills the bearing gap from leaking out onto the outer parts via said mating gap.

Also, since the axial length of the case is shortened, the manufacturing by machining or press processing becomes easier, requires fewer materials, and mass producibility of the fluid dynamic pressure bearings is improved achieving a lower manufacturing costs. Particularly in cases where the case is formed by plastic work like press processing or tube rolling, it is possible to reduce the manufacturing steps required by the precision machining process of the case. Furthermore, the quality can be maintained, and improved mass producibility and much lower costs can be achieved.

Further features and advantages will appear more clearly on a reading of the detailed description, which is given below by way of example only and with reference to the accompanying drawings wherein corresponding reference characters on different drawings indicate corresponding parts.

### BRIEF DESCRIPTION OF THE DRAWINGS

FIG. 1 is a schematic vertical cross-sectional view of the fluid dynamic pressure bearing of the first embodiment of this invention.

FIG. 2 is a schematic vertical cross-sectional view of the fluid dynamic pressure bearing of the second embodiment of this invention.

FIG. 3 is a schematic vertical cross-sectional view of the fluid dynamic pressure bearing of the third embodiment of this invention.

FIG. 4 is a schematic vertical cross-sectional view of the fluid dynamic pressure bearing of the fourth embodiment of this invention.

FIG. 5 is a schematic vertical cross-sectional view of the fluid dynamic pressure bearing of the fifth embodiment of this invention.

FIG. 6 is a schematic vertical cross-sectional view of the fluid dynamic pressure bearing of the sixth embodiment of this invention.

FIG. 7 is a schematic vertical cross-sectional view of the fluid dynamic pressure bearing of the seventh embodiment of this invention.

FIG. 8 is a schematic vertical cross-sectional view of the spindle motor of the eighth embodiment of this invention.

FIG. 9 is a schematic vertical cross-sectional view of the hard disk drive unit of the ninth embodiment of this invention.

FIG. 10 is a schematic vertical cross-sectional view of a conventional fluid dynamic pressure bearing.

FIG. 11 is a schematic vertical cross-sectional view of another example of conventional fluid dynamic pressure bearing.

### DETAILED DESCRIPTION

### Embodiment 1

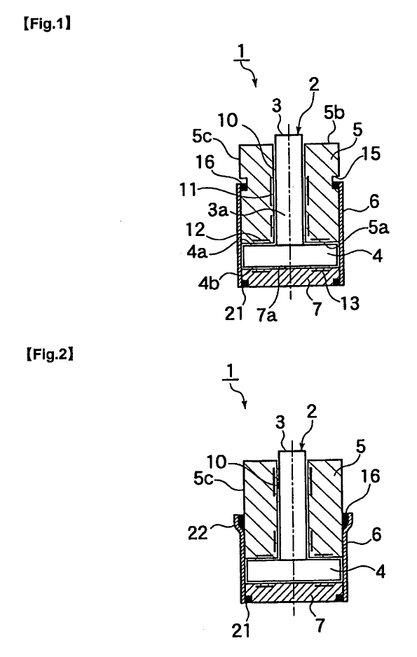

FIG. 1 is a schematic vertical cross-sectional view of a fluid dynamic pressure bearing of the first embodiment. The fluid dynamic pressure bearing 1 supports free rotation of a rotating shaft 2 having a flange part 4. The free rotation is supported via radial microgaps formed between the shaft 2 and a sleeve 5. The sleeve 5 has radial dynamic pressure generating grooves 11 on the inner circumference. The flange part 4 is inserted and held sandwiched between the lower end surface 5a of the sleeve 5 where thrust dynamic pressure generating grooves 12 are formed, and the upper surface 7a of the endplate 7 where more thrust dynamic pressure generating grooves 13 are formed. The lower end-surface 5a and the upper surface 4a and the upper surface 7a and the lower surface 4b oppose each other via thrust microgaps. Radial dynamic pressure generating grooves 11 and the thrust dynamic pressure generating grooves 12, 13 could be formed respectively on the outer circumferential surface 3a of the shaft body 3 of the rotating shaft 2, the upper surface 4a of the flange part 4, and the lower surface 4b of the flange part 4.

The endplate 7 is fitted into the lower end part of the case 6, and its lower edge is fixed to inner circumferential surface of the lower end part of the case 6 by an adhesive 21. Also, the upper end surface 5b of the sleeve 5 projects out from the upper end surface of the case 6 when the sleeve is fitted into the case 6. The type of fitting between the sleeve 5 and case 6 may be an interference fit, a clearance fit or a transition fit. In the case of a transition fit, either a clearance or an interference may result when mating parts are assembled depending upon the actual manufactured dimensions of the mating parts.

The circumferential grooves 15 for filling with adhesive are formed in a depressed manner on the outer circumferential surface 5c of the sleeve 5. An adhesive 16 fills the adhesive reservoir (the first reservoir) formed between these circumferential grooves 15 and the inner circumferential surface of the upper end part of the case 6. Adhesive 16 is securely retained in the reservoir and the outer circumferential surface 5c of the sleeve 5 is fixed to the inner circumferential surface of the case 6 by the adhesive 16.

When the sleeve 5 is fastened onto the case 6 by the adhesive 16 using the manner of fastening as described above, it is possible to prevent the adhesive 16 from adhering on the inner circumferential surface of the sleeve 5 and other areas outside the prescribed filling site during the adhesive filling time. Also, during the state before the adhesive is completely set, the adhesive no longer discharges to outer areas due to handling or from external force and it is possible to reduce unnecessary work such as removal of adhesive that has discharged or adhered in areas outside the prescribed filling site.

When the sleeve 5 is inserted into the case 6 by an clearance fit or by transition fit, it is slidable relative to the case 6 and the sleeve 5 is aligned with high precision in the axial direction relative to the case 6 by applying an appropriate load in the axial direction at an arbitrary one end of the sleeve 5 and fixing in the case 6 by the adhesive 16. This is very important issue to achieve a stable and highly efficient mass production of fluid dynamic pressure bearings 1 while maintaining the perpendicularity and the concentricity of the sleeve 5 and the case 6 relative to the axial center of the fluid dynamic pressure bearing 1, the parallelism between the sleeve 5 and the case 6, and the flatness of the sleeve end surface within the desired accuracy. When inserting the sleeve 5 in the case 6, it is also effective in making assembly easier and minimizing deviations in dimensional and geometrical accuracy (dimensions of inner diameter, roundness, etc.) due to press fitting on the sleeve 5 inner peripheral face even if deformation of the sleeve 5 occurs easily due to thin thickness in the radial direction.

In this case, when a viscosity of the adhesive 16 for filling the adhesive reservoir is appropriately selected, the adhesive travels by the capillary phenomenon over the whole area of the mating gap formed between the outer circumferential surface 5c of the sleeve 5 and the inner circumferential surface 6 of the case. After the adhesive has set completely, the outer circumferential surface 5c of the sleeve 5 and the inner circumferential surface of the case 6 are fastened together in a secure and airtight manner by the adhesive passing over the whole circumference. The seal function of said mating gap is thus reliably ensured and it is possible to reliably prevent the lubricant filling the bearing gap from leaking out onto the outer part via said mating gap.

The case 6 is formed of either steel, stainless steel, or other, non-ferrous alloys by press processing or tube rolling. Although the wall thickness of the case 6 is considerably thinner than the case in the conventional fluid dynamic pressure bearings, processing is easy because the axial length is shorter than in conventional models. Consequently, manufacturing the case 6 by the aforementioned processing method is easy, and the manufacturing costs associated with conventional precision machine processing can be reduced. Moreover, since the quality can be maintained, and the cost of materials can be curtailed, the ability to mass-produce and manufacture the fluid dynamic pressure bearings can be boosted, and lower costs can be achieved.

### Embodiment 2

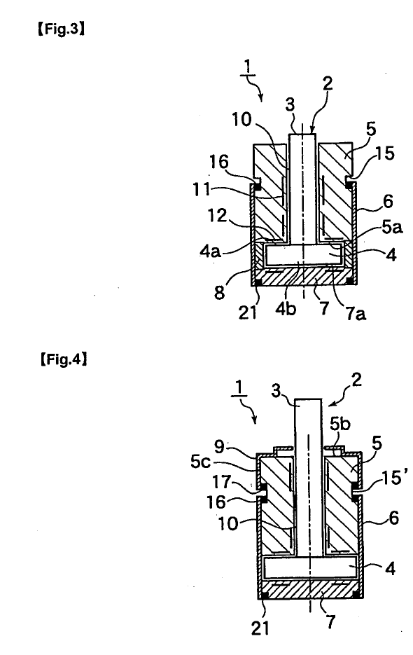

FIG. 2 is a schematic vertical cross-sectional view of the fluid dynamic pressure bearing of the second embodiment. A fluid dynamic pressure bearing 1 of Embodiment 2 differs from the fluid dynamic pressure bearing of the first embodiment in the formation of the adhesive reservoir which is filled by the adhesive 16, as shown in FIG. 2.

In the fluid dynamic pressure bearing 1 of this second embodiment, the upper end part of the case 6 is diametrically expanded, forming the diametrically expanded upper part 22. The expanded upper part 22 is easier to form as compared to circumferential grooves of the first embodiment. The space formed between this diametrically expanded upper end part 22 and the outer circumferential surface 5c of the sleeve 5 is filled by the adhesive 16 to achieve the same effects as in the first embodiment.

### Embodiment 3

FIG. 3 is a schematic vertical cross-sectional view of the fluid dynamic pressure bearing 1 of the third embodiment. The fluid dynamic pressure bearing 1 of the third embodiment differs from the fluid dynamic pressure bearing of the first embodiment in that when the sleeve 5 is fitted onto the case 6 and affixed there, a positioning component 8 is interposed between the sleeve 5 and the endplate 7.

The positioning component 8 allows accurate positioning of the sleeve 5 that is fitted in the case 6. This in turn allows forming accurately the prescribed size of the bearing gap between the upper surface 4a of the flange part 4 and the lower end surface 5a of the sleeve 5, and between the lower surface 4b of the flange part 4 and the upper surface 7a of the endplate 7.

### Embodiment 4

FIG. 4 is a schematic vertical cross-sectional view of the fluid dynamic pressure bearing 1 of the fourth embodiment. The fluid dynamic pressure bearing 1 of Embodiment 4 differs from the fluid dynamic pressure bearing of the first embodiment in that it has a seal cover 9 that is fitted on and covers the outer circumferential surface part of the sleeve 5 projecting out from the upper end surface of the case 6. A lower end part of this seal cover 9 is fixed onto the outer circumferential surface 5c of the sleeve 5, as shown in FIG. 4.

The seal cover 9 is a cap component whose shape combines a disc part and a cylinder part. The disc part has a stepped composition with a large diameter part and a small diameter part, and there is a hole in the center part that the body of the rotating shaft 3 passes through. This seal cover 9 is inserted on the shaft body 3 without coming into contact with it. Also, the open end of the bearing is sealed on the outside, preventing contamination of the bearing.

The lower end part of the seal cover 9 fixed to the outer circumferential surface 5c of the sleeve 5 by an adhesive 17 filling the adhesive reservoir (the second reservoir) formed between said lower end part and the circumferential groove 15′ formed on the outer circumferential surface 5c of the sleeve 5. The circumferential groove 15′ including the first and the second reservoirs is formed by slightly extending the width of the circumferential groove 15 in Embodiment 1.

In this manner, since the lower end part of the seal cover 9 is fixed onto the outer circumferential surface 5c of the sleeve 5 by the adhesive 17 filling the second reservoir, it is possible to prevent the adhesive 17 from adhering to areas outside of the prescribed filling site during the adhesive filling. The adhesive 17 no longer discharges onto the outer parts before it has completely set due to handling or external force, and it is possible to reduce unnecessary work such as removal of the adhesive, which has discharged or adhered in an area outside the prescribed filling site. Also, the two reservoirs (the first and second reservoirs) of the adhesive are both formed in the same groove on the outer circumferential surface 5c of the sleeve 5, and are provided so that they mutually approach each other. Due to their proximity, the injection of the adhesive in the first and second reservoir can be done at the same time to increase the manufacturing efficiency for fluid dynamic pressure bearing 1.

### Embodiment 5

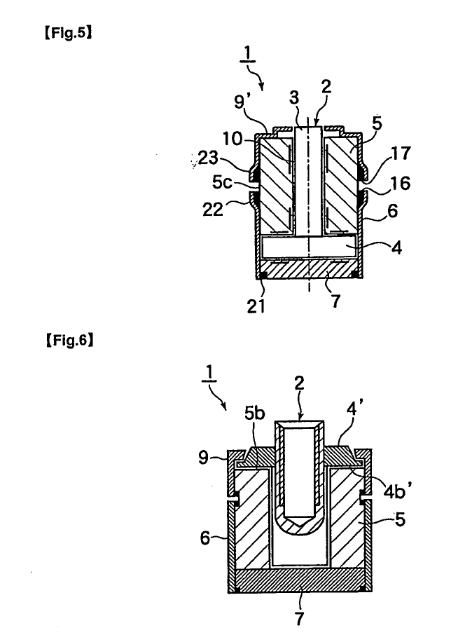

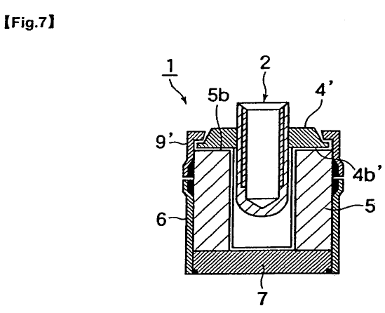

FIG. 5 is a schematic vertical cross-sectional view of the fluid dynamic pressure bearing of the fifth embodiment. The fluid dynamic pressure bearing 1 of Embodiment 5 differs from the fluid dynamic pressure bearing of the second embodiment in having a seal cover 9′, which is fitted on and covers the outer circumferential surface part of the sleeve 5 projecting out from the upper end surface of the case 6. A lower end part of this seal cover 9′ is fixed onto the outer circumferential surface 5c of the sleeve 5, as shown in FIG. 5.

In contrast with the seal cover 9 of Embodiment 4, the seal cover 9′ differs in regard to the lower end part of the seal cover 9′, which is diametrically expanded, forming a diametrically expanded lower end part 23. As a result the second reservoir of the adhesive in Embodiment 5 is formed between this diametrically expanded lower end part 23 and the outer circumferential surface 5c of the sleeve 5. Said second reservoir has the same shape as the first reservoir, and it is desirable that the two are made to approach and face each other. The diametrically expanded lower end part 23 is formed in place of circumferential groove 15′ of embodiment 4.

Since the effects of fitting of this seal cover 9′ are roughly the same as in Embodiment 4, and since the other results and aspects of its composition are the same as in Embodiment 2, a more detailed explanation has been omitted.

### Embodiment 6

FIG. 6 is a schematic vertical cross-sectional view of the fluid dynamic pressure bearing of the sixth embodiment. As shown in FIG. 6, the fluid dynamic pressure bearing 1 of the sixth embodiment has a flange part 4′ attached to the upper end portion of rotating shaft 2. This flange part 4′ is positioned on the upper end surface 5b of the sleeve 5. The thrust dynamic pressure generating grooves are formed on the upper end surface 5b. The upper end surface 5b of said sleeve 5 and the lower surface 4b′ of the flange part 4′ oppose each other via thrust microgaps formed between them.

The seal cover 9 covers the outer circumferential surface of the sleeve 5 that extends from the upper end surface of the case 6. The seal cover 9 covers the portion of the upper surface of the flange part 4′ including at least the area in the vicinity of the outer circumferential edge of flange part 4′. Microgaps are provided between the seal cover 9 and the flange part 4′. The flange part 4′ smoothly rotates relative to the seal cover 9. The seal cover 9 restricts the upward movement of the area in the vicinity of the outer circumferential edge of the flange part 4′, retaining the rotating shaft 2, as well as seals the lubricant that fills the thrust dynamic pressure generating region and the radial dynamic pressure generating region. Furthermore, although in the present embodiment the endplate 7 is fitted on the lower end part of the tube-shaped case 6 so that it blocks the bottom end of the sleeve 5, a cup-shaped case 6 can be formed by press processing, making it possible to omit the endplate 7. Although this sixth embodiment differs in the aforementioned ways from Embodiment 4 (see FIG. 4), the two are not significantly different in other respects. A detailed explanation has therefore been omitted.

### Embodiment 7

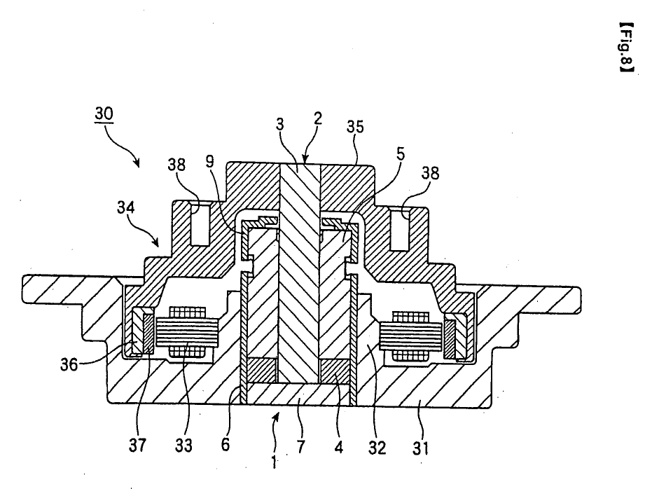

FIG. 7 is a schematic vertical cross-sectional view of the fluid dynamic pressure bearing of the seventh embodiment. The fluid dynamic pressure bearing 1 of Embodiment 7 results from applying the flanged rotating shaft 2 and the seal cover 9 of Embodiment 6 to the Embodiment 5 in order to simultaneously realize a lubricant sealing structure and a shaft retaining structure. In other respects, it basically does not differ from Embodiment 5. Thus, excluding the effect of the seal cover 9′ of Embodiment 5 covering the bearing aperture end to prevent the contamination of the bearing, the present construction combines all the other previously described effects of Embodiment 5 and the effect of Embodiment 6 that simultaneously realizes a lubricant sealing structure and a shaft retaining structure using the flanged rotating shaft 2 and the seal cover 9. The case 6 of embodiment 7 is similar to the case 6 of embodiment 5. Consequently, a more detailed explanation regarding this seventh embodiment has been omitted. Furthermore, in this seventh embodiment, if a cup-shaped case 6 is formed by press processing, the endplate 7 may be omitted as in Embodiment 6.

### Embodiment 8

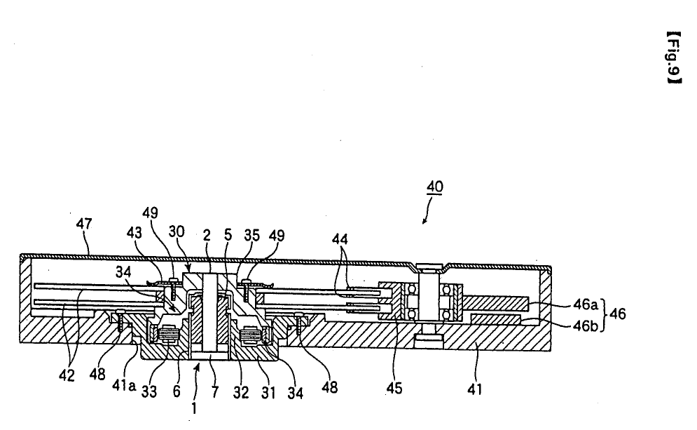

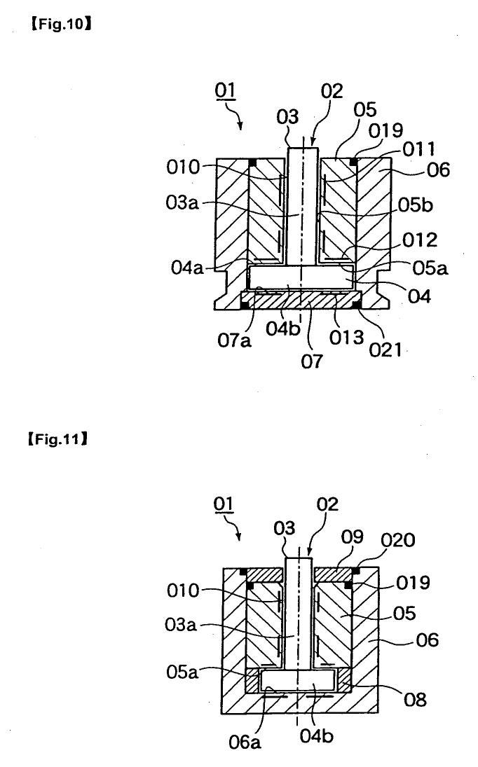

FIG. 8 is a schematic longitudinal cross-sectional view of a spindle motor of Embodiment 8 having a fluid dynamic pressure bearing of Embodiment 4 (See FIG. 4). In this case, a spindle motor having the fluid dynamic pressure bearing of Embodiment 4 is shown, but fluid dynamic pressure bearings of Embodiment 1 through 3, and 5 through 7 can also be used. Of course various modifications can be made without exceeding the objectives of the present invention.

As shown in FIG. 8, the spindle motor 30 of Embodiment 8 has a frame 31 which will be fixed on a housing 41 for a hard disk drive device 40 as subsequently described. A stator 33 wherein a coil is wound around the stator core is installed on the outer peripheral face of the boss portion 32. In addition a fluid dynamic pressure bearing 1 of Embodiment 4 is installed on the inner peripheral face of the boss portion 32 so that a rotor 34 is supported rotatably relative to the stator 33 using the fluid dynamic pressure bearing 1.

The case 6 of the fluid dynamic pressure bearing 1 is installed on the inner peripheral face of the boss portion 32. A thermosetting adhesive is used in order to prevent the formation of a gap between the outer surface of case 6 and the inner surface of the boss portion 32.

The rotor 34 contains a rotor hub 35 installed at the upper end portion of the rotary shaft 2 and a rotor magnet 37 that is installed on the inner peripheral face of the outer peripheral cylinder portion of the rotor hub 35 via a yoke 36. Rotor magnet 37 generates a rotary magnetic field in coordination with the stator 33. The spindle motor 30 of Embodiment 8 is an outer rotor type motor, but it is not limited to this.

In the middle step portion of the rotor hub 35, multiple screw holes 38 are formed in the axial direction and as will be described later, a clamp member 43 is screwed in the screw holes 38 to fix a hard disk 42. Although it is not illustrated, a flexible wiring circuit board is fixed on the spindle motor 30 and a control current is supplied from the output terminal of the wiring circuit board to the coil in the stator 33 in order to start rotating the rotor assembly (rotor) 34 consisting of a rotor hub 35, a yoke 36 and a rotor magnet 37 and a rotary shaft 2 relative to the stator 33.

In the spindle motor 30 of Embodiment 8, the rotor 34 is stably supported in a non-contact state relative to each bearing surface (inner surface of sleeve 5, lower end surface 5a of the sleeve 5, upper surface 7a of the endplate 7, see FIG. 1) by the equilibrium between upward and downward forces resulting from the dynamic pressure generated at the bearing surfaces when the rotary shaft 2 rotates.

Since the spindle motor 30 of Embodiment 8 has the said configuration, the adhesive does not adhere or flow to the locations other than the specified locations to be filled at the time of assembly of the fluid dynamic pressure bearing 1, and does not contaminate the motor or does not enter into the interior of the bearing so that high precision rotation is not affected and highly reliable spindle motor 30 can be mass produced at a low cost.

### Embodiment 9

FIG. 9 is a schematic longitudinal cross-sectional view of a hard disk drive unit of Embodiment 9 equipped with a spindle motor of Embodiment 8 (See FIG. 8). The hard disk drive unit 40 of Embodiment 9 as shown in FIG. 9 includes a housing 41 containing a spindle motor 30 of Embodiment 8 and a cover member 47 forming a clean space with limited dust by sealing the housing 41.

A spindle motor 30 is fixed in the housing 41 by screwing installation screws 48 through the multiple through-holes made in the frame 31. The housing 41 is clamped during installation of motor 30. In this way, a main body portion containing a stator 33 and a rotor 34 of the spindle motor 30 is placed inside of the box of the hard disk drive unit 40. As a modification example, a single component housing can be formed by integration of the frame 31 with the housing 41 and the housing can have a structure such that it becomes at the same time a part of the spindle motor and a part of the box of the hard disk drive unit 40.

On the outer peripheral face of the middle cylindrical portion of the rotor hub 35, two sheets of hard disk 42 (recording disks) are installed. The hard disk 42 is fixed at the rotor hub 35 via the clamp 43 by screwing installation screws 49 into multiple screw holes in the middle step of the rotor hub 35. As a result, the hard disk 42 rotates integrally along with the rotor hub 35. In the example shown in FIG. 9, two sheets of hard disk 42 are installed at the rotor hub 35, but the number of sheets of hard disks is not limited to this number.

The hard disk drive unit 40 comprises of a magnetic head (recording head) to write and read information for the hard disk 42. A magnetic head 44, an arm 45 for supporting the magnetic head 44 via suspension, and a voice coil motor 46 that moves the magnetic head 44 and the arm 45 to the desirable positions are included in the hard disk drive unit 40. The voice coil motor 46 contains a coil 46a and a magnet 46b facing the coil 46a.

A magnetic head 44 is installed at the tip of the suspension fixed on the arm 45 which is supported rotatably at appropriate positions in the housing 41. A pair of magnetic heads 44 is used for each hard disk so that information can be written or read on both sides of the hard disk 42. In the example shown in FIG. 9, two sheets of hard disk 42 are configured so that two pairs of magnetic heads 44 are installed.

Since the hard disk drive unit 40 of Example of Embodiment 9 has such a configuration described above, the adhesive does not adhere or flow to the locations other than the specified locations to be filled and does not contaminate the interior of the unit during the assembly of the fluid dynamic pressure bearing 1, allowing mass production of a highly reliable hard disk drive unit 40 at a low cost.

In Embodiment 9, a spindle motor 30 is used in the hard disk drive unit 40, but the use of the spindle motor 30 is not limited to this. For example, the hard disk drive unit 40 can be replaced by a recording disk drive unit using optical recording disks such as CDs and DVDs while replacing magnetic head 44 with an optical head. In this case, the same effects can be achieved.

The present invention is not limited to the examples listed above and can be modified in the range not exceeding the objective of the invention. For example, in Examples of Embodiment 1 through 9, the fluid dynamic pressure bearing 1 was assumed to be all the axially rotary type, but the invention is equally applicable to an axially fixed type bearing. In the spindle motor using an axially fixed fluid dynamic pressure bearing, the rotary shaft 2 is fixed in the frame 31 and becomes a fixed shaft and the rotary hub 35 is installed on the case 6. Other configurations of the spindle motor are not basically different from the configuration of the spindle motor 30 of Embodiment 8 and are clear to those in the art so that detailed explanations will be omitted. Various modifications apparent to one skilled in the art are intended to fall within the scope of the appended claims.

I claim:

1. A fluid dynamic bearing comprising:
a case having a first end and a second end;
a sleeve fitted into the case, the sleeve having a third end and a fourth end, the fourth end of the sleeve projecting beyond the second end of the case;
a groove formed on the sleeve adjacent to the second end of the case;
a first adhesive reservoir formed between the second end of the case and the groove; and
a first adhesive injected in the first adhesive reservoir to adhere the case to the sleeve.

2. The fluid dynamic bearing of claim 1, wherein the case is formed by press processing or tube rolling.

3. The fluid dynamic bearing of claim 1, further comprising:
a seal cover having a top end and a bottom end, the seal cover fitted on the fourth end of the sleeve, and wherein the bottom end of the seal cover is adjacent to the groove formed on the sleeve;
a second adhesive reservoir formed between the bottom end of the seal cover and the groove; and
a second adhesive injected in the second adhesive reservoir to adhere the seal cover to the sleeve.

4. The fluid dynamic bearing of claim 3, wherein the seal cover is formed by press processing or tube rolling.

5. The fluid dynamic bearing of claim 3, wherein the viscosity of the first and the second adhesives is selected so that the first and the second adhesives filling the first and the second reservoirs respectively spread into gaps between the case and the sleeve and between the seal cover and the sleeve by capillary phenomenon, thereby sealing said gaps airtightly after complete setting of the adhesives.

6. The fluid dynamic bearing of claim 1, wherein the sleeve is fitted in the case with a gap between the case and the sleeve and the gap is sealed by the first adhesive.

7. The fluid dynamic bearing of claim 6, wherein the viscosity of the first adhesive is selected so that the first adhesive filling the first reservoir spreads into the gap between the case and the sleeve by capillary phenomenon, thereby sealing said gap airtightly after complete setting of the adhesive.

8. The fluid dynamic bearing of claim 1, wherein the sleeve is fitted in the case with a tight fit.

9. A fluid dynamic bearing comprising:
a case having a first end and a second end;
a sleeve fitted into the case, the sleeve having a third end and a fourth end, the fourth end of the sleeve projecting beyond the second end of the case;
a first expanded diameter formed at the second end of the case;
a first adhesive reservoir formed between the first expanded diameter part of the second end of the case and the sleeve; and
a first adhesive injected in the first adhesive reservoir to adhere the case to the sleeve.

10. The fluid dynamic bearing of claim 9, wherein the case is formed by press processing or tube rolling.

11. The fluid dynamic bearing of claim 9, further comprising:
a seal cover having a top end and a bottom end, the seal cover fitted on the fourth end of the sleeve;
a second expanded diameter formed at the bottom end of the seal cover;
a second adhesive reservoir formed between the second expanded diameter of the bottom end of the seal cover and the sleeve; and
a second adhesive injected in the second adhesive reservoir to adhere the seal cover to the sleeve.

12. The fluid dynamic bearing of claim 11, wherein the seal cover is formed by press processing or tube rolling.

13. The fluid dynamic bearing of claim 11, wherein the viscosity of the first and the second adhesives is selected so that the first and the second adhesives filling the first and the second reservoir respectively will spread into gaps between the case and the sleeve and the seal cover and the sleeve by capillary phenomenon, thereby sealing said fitting gaps airtightly after complete setting of the adhesives.

14. The fluid dynamic bearing of claim 9, wherein the sleeve is fitted in the case with a gap between the case and the sleeve and the gap is sealed by the first adhesive.

15. The fluid dynamic bearing of claim 14, wherein the viscosity of the first adhesive is selected so that the first adhesive filling the first reservoir spreads into the gap between the case and the sleeve by capillary phenomenon, thereby sealing said gap airtightly after complete setting of the adhesive.

16. The fluid dynamic bearing of claim 9, wherein the sleeve is fitted in the case with a tight fit.

17. A spindle motor comprising:
a fluid dynamic bearing, the fluid dynamic bearing comprising:
a case having a first end and a second end;
a sleeve fitted into the case, the sleeve having a third end and a fourth end, the fourth end of the sleeve projecting beyond the second end of the case;
a groove formed on the sleeve adjacent to the second end of the case;
a first adhesive reservoir formed between the second end of the case and the groove; and
a first adhesive injected in the first adhesive reservoir to adhere the case to the sleeve.

18. The spindle motor of claim 17, wherein the case is formed by press processing or tube rolling.

19. The spindle motor of claim 17, further comprising:
a seal cover having a top end and a bottom end, the seal cover fitted on the fourth end of the sleeve, and wherein the bottom end of the seal cover is adjacent to the groove formed on the sleeve;
a second adhesive reservoir formed between the bottom end of the seal cover and the groove; and
a second adhesive injected in the second adhesive reservoir to adhere the seal cover to the sleeve.

20. The spindle motor of claim 19, wherein the seal cover is formed by press processing or tube rolling.

21. The spindle motor of claim 19, wherein the viscosity of the first and the second adhesives is selected so that the first and the second adhesives filling the first and the second reservoir respectively will spread into gaps between the case and the sleeve and the seal cover and the sleeve by capillary phenomenon, thereby sealing said fitting gaps airtightly after complete setting of the adhesives.

22. The spindle motor of claim 17, wherein the sleeve is fitted in the case with a gap between the case and the sleeve and the gap is sealed by the first adhesive.

23. The spindle motor of claim 22, wherein the viscosity of the first adhesive is selected so that the first adhesive filling the first reservoir spreads into the gap between the case and the sleeve by capillary phenomenon, thereby sealing said gap airtightly after complete setting of the adhesive.

24. The spindle motor of claim 17, wherein the sleeve is fitted in the case with a tight fit.

25. A spindle motor comprising:
a fluid dynamic bearing, the fluid dynamic bearing comprising:
a case having a first end and a second end;
a sleeve fitted into the case, the sleeve having a third end and a fourth end, the fourth end of the sleeve projecting beyond the second end of the case;
a first expanded diameter formed at the second end of the case;
a first adhesive reservoir formed between the first expanded diameter part of the second end of the case and the sleeve; and
a first adhesive injected in the first adhesive reservoir to adhere the case to the sleeve.

26. The spindle motor of claim 25, wherein the case is formed by press processing or tube rolling.

27. The spindle motor g of claim 25, further comprising:
a seal cover having a top end and a bottom end, the seal cover fitted on the fourth end of the sleeve;
a second expanded diameter formed at the bottom end of the seal cover;
a second adhesive reservoir formed between the second expanded diameter of the bottom end of the seal cover and the sleeve; and
a second adhesive injected in the second adhesive reservoir to adhere the seal cover to the sleeve.

28. The spindle motor of claim 27, wherein the seal cover is formed by press processing or tube rolling.

29. The spindle motor of claim 27, wherein the viscosity of the first and the second adhesives is selected so that the first and the second adhesives filling the first and the second reservoir respectively will spread into gaps between the case and the sleeve and the seal cover and the sleeve by capillary phenomenon, thereby sealing said fitting gaps airtightly after complete setting of the adhesives.

30. The spindle motor of claim 25, wherein the sleeve is fitted in the case with a gap between the case and the sleeve and the gap is sealed by the first adhesive.

31. The spindle motor of claim 30, wherein the viscosity of the first adhesive is selected so that the first adhesive filling the first reservoir spreads into the gap between the case and the sleeve by capillary phenomenon, thereby sealing said gap airtightly after complete setting of the adhesive.

32. The spindle motor of claim 25, wherein the sleeve is fitted in the case with a tight fit.

33. A recording disk drive device comprising:
a spindle motor, the spindle motor comprising:
a fluid dynamic bearing, the fluid dynamic bearing comprising:
a case having a first end and a second end;
a sleeve fitted into the case, the sleeve having a third end and a fourth end, the fourth end of the sleeve projecting beyond the second end of the case;
a groove formed on the sleeve adjacent to the second end of the case;
a first adhesive reservoir formed between the second end of the case and the groove; and
a first adhesive injected in the first adhesive reservoir to adhere the case to the sleeve.

34. The recording disk drive device of claim 33, wherein the case is formed by press processing or tube rolling.

35. The recording disk drive device of claim 33, further comprising:
a seal cover having a top end and a bottom end, the seal cover fitted on the fourth end of the sleeve, and wherein the bottom end of the seal cover is adjacent to the groove formed on the sleeve;
a second adhesive reservoir formed between the bottom end of the seal cover and the groove; and
a second adhesive injected in the second adhesive reservoir to adhere the seal cover to the sleeve.

36. The recording disk drive device of claim 35, wherein the seal cover is formed by press processing or tube rolling.

37. The recording disk drive device of claim 35, wherein the viscosity of the first and the second adhesives is selected so that the first and the second adhesives filling the first and the second reservoir respectively will spread into gaps between the case and the sleeve and the seal cover and the sleeve by capillary phenomenon, thereby sealing said fitting gaps airtightly after complete setting of the adhesives.

38. The recording disk drive device of claim 33, wherein the sleeve is fitted in the case with a gap between the case and the sleeve and the gap is sealed by the first adhesive.

39. The fluid dynamic bearing of claim 38, wherein the viscosity of the first adhesive is selected so that the first adhesive filling the first reservoir spreads into the gap between the case and the sleeve by capillary phenomenon, thereby sealing said gap airtightly after complete setting of the adhesive.

40. The recording disk drive device of claim 33, wherein the sleeve is fitted in the case with a tight fit.

41. A recording disk drive device comprising:
a spindle motor, the spindle motor comprising:
a fluid dynamic bearing, the fluid dynamic bearing comprising:
a case having a first end and a second end;
a sleeve fitted into the case, the sleeve having a third end and a fourth end, the fourth end of the sleeve projecting beyond the second end of the case;
a first expanded diameter formed at the second end of the case;
a first adhesive reservoir formed between the first expanded diameter part of the second end of the case and the sleeve; and
a first adhesive injected in the first adhesive reservoir to adhere the case to the sleeve.

42. The recording disk drive device of claim 41, wherein the case is formed by press processing or tube rolling.

43. The recording disk drive device of claim 41, further comprising:
a seal cover having a top end and a bottom end, the seal cover fitted on the fourth end of the sleeve;
a second expanded diameter formed at the bottom end of the seal cover;
a second adhesive reservoir formed between the second expanded diameter of the bottom end of the seal cover and the sleeve; and
a second adhesive injected in the second adhesive reservoir to adhere the seal cover to the sleeve.

44. The recording disk drive device of claim 43, wherein the seal cover is formed by press processing or tube rolling.

45. The recording disk drive device of claim 43, wherein the viscosity of the first and the second adhesives is selected so that the first and the second adhesives filling the first and the second reservoir respectively will spread into gaps between the case and the sleeve and the seal cover and the sleeve by capillary phenomenon, thereby sealing said fitting gaps airtightly after complete setting of the adhesives.

46. The recording disk drive device of claim 41, wherein the sleeve is fitted in the case with a gap between the case and the sleeve and the gap is sealed by the first adhesive.

47. The fluid dynamic bearing of claim 46, wherein the viscosity of the first adhesive is selected so that the first adhesive filling the first reservoir spreads into the gap between the case and the sleeve by capillary phenomenon, thereby sealing said gap airtightly after complete setting of the adhesive.

48. The recording disk drive device of claim 41, wherein the sleeve is fitted in the case with a tight fit.
